(19) United States
(12) Patent Application Publication
(10) Pub. No.: US 2022/0127692 A1
(43) Pub. Date: Apr. 28, 2022

(54) GRAIN-ORIENTED ELECTRICAL STEEL SHEET, AND METHOD OF MANUFACTURING SAME

(71) Applicant: NIPPON STEEL CORPORATION, Tokyo (JP)

(72) Inventors: Satoshi ARAI, Tokyo (JP); Masataka IWAKI, Tokyo (JP); Masato MIZOKAMI, Tokyo (JP); Hideyuki HAMAMURA, Tokyo (JP); Takeo ARAMAKI, Tokyo (JP); Hirotoshi TADA, Tokyo (JP)

(73) Assignee: NIPPON STEEL CORPORATION, Tokyo (JP)

(21) Appl. No.: 17/424,079

(22) PCT Filed: Jan. 28, 2020
(86) PCT No.: PCT/JP2020/002983

§ 371 Date: Jul. 19, 2021

(30) Foreign Application Priority Data
Jan. 28, 2019 (JP) 2019-012090

(51) Int. Cl. C21D 10/00; C21D 9/46; H01F 1/147

(52) U.S. Cl. CPC C21D 10/005; C21D 9/46; H01F 41/00; C21D 2201/05; H01F 1/147

(57) ABSTRACT

A grain-oriented electrical steel sheet includes: a steel sheet and optionally an insulation coating formed on the steel sheet, in which, in a case where a heat treatment of performing retention at 800° C. for 2 hours is performed, regarding a time-magnetostriction waveform (t−λ waveform) when magnetized to 1.7 T, a peak value of a difference waveform obtained by subtracting the time-magnetostriction waveform after the heat treatment from the time-magnetostriction waveform before the heat treatment is 0.01×10⁻⁶ or more and 0.20×10⁻⁶ or less, and a difference obtained by subtracting an iron, loss before the heat treatment from an iron loss after the heat treatment is 0.03 W/kg or more and 0.17 W/kg or less.

### TECHNICAL FIELD OF THE INVENTION

The present invention relates to a grain-oriented electrical steel sheet suitably used for a core of a transformer or the like and a method of manufacturing the same. More particularly, the present invention relates to a grain-oriented electrical steel sheet causing low iron loss and low noise, which contributes to not only a reduction in iron loss of a core but also a reduction in noise, and a method of manufacturing the same.

Priority is claimed on Japanese Patent Application No. 2019-012090, filed Jan. 28, 2019, the content of which is incorporated herein by reference.

### RELATED ART

In recent years, reduction of noise and vibration has been increasingly required for electromagnetic application devices such as transformers, and a grain-oriented electrical steel sheet used for the core of a transformer has been required to be a material suitable for low noise and low vibration as well as low iron loss. It is said that one of the causes arising from a material for the noise and vibration of a transformer is the magnetostriction of a grain-oriented electrical steel sheet. The magnetostriction mentioned here is the vibration that is seen in a rolling direction of the grain-oriented electrical steel sheet, which occurs by slightly changing the outer shape of the grain-oriented electrical steel sheet with a change in the magnetization intensity when a grain oriented electrical steel sheet is magnetized by an alternating magnetic field. The magnitude of the magnetostriction is as small as the order of 10⁻⁶. However, the magnetostriction causes vibration in the core, which propagates through an external structure such as the tank of a transformer and becomes noise.

The magnetostriction characteristics change depending on various factors such as the structure and state of the grain-oriented electrical steel sheet, specifically, the integration degree of crystal orientations, the tension applied to the steel sheet by an insulation coating, and the strain inherent in the steel. When the magnetostriction characteristics change, the noise level changes, and in some cases, the noise can be reduced.

As one of the processes to change the magnetostriction characteristics, a technique of locally irradiating the surface of a grain-oriented electrical steel sheet with a laser, an electron beam, or the like to refine the magnetic domains is known. In general, the irradiation with the laser or the like is performed linearly in a direction substantially orthogonal to the rolling direction of the steel sheet. As a result, closure magnetic domains extending in the irradiation direction are formed and striped magnetic domains are refined, resulting in a reduction in iron loss. On the other hand, by the irradiation with the laser or the like, the magnetostriction characteristics can also be changed and the noise level can also be changed. Therefore, irradiation conditions that can lower the iron loss and reduce noise are required.

Patent Document 1 has an object to provide a grain-oriented electrical steel sheet causing low iron loss and low noise with which both low iron loss and low noise of a transformer can be achieved, focuses on the magnetostriction 0-p value at a saturation magnetic flux density and the difference between the magnetostriction 0-p value at a saturation magnetic flux density and the magnetostriction 0-p value at 1.7 T, and proposes causing such a difference before and after laser irradiation to be a predetermined value or less.

However, in the grain-oriented electrical steel sheet of Patent Document 1, the grain-oriented electrical steel sheet causing low noise is produced by focusing only on the difference in magnetostriction peak intensity, and it cannot be said that low iron loss and low noise are sufficient for the high demands of recent years.

Patent Document 2 has an object to provide a grain-oriented electrical steel sheet capable of changing and reducing a noise level with respect to noise generated by a transformer or a reactor by changing the magnetostriction characteristics of a steel sheet as a material of a core, and proposes specifying the amplitude of a magnetostriction component at a 4f frequency when the grain-oriented electrical steel sheet subjected to magnetic domain refinement by linear strain is magnetized at a fundamental frequency f, and specifying the difference in amplitude before and after SRA.

However, in Patent Document 2, although the amplitude of the magnetostriction component at the 4f frequency is specified based on the finding that the magnetostriction of the 4f component depends on the shape of closure magnetic domains generated by the local introduction of strain, other frequency components are not considered, and a reduction in iron loss is not sufficiently examined.

Patent Document 3 has an object to provide a unidirectional electrical steel sheet for a low noise transformer, which effectively reduces noise by reducing harmonics having a large effect on human hearing, and proposes smoothing a change in magnetostriction waveform by causing magnetostriction λ_{0-B} (difference in the shape of the steel sheet when a magnetic flux density is B T and 0 T) to be in a range of 0≤λ_{0-B}≤0.5×10⁻⁶ using laser irradiation and the tension of a coating.

However, in the grain-oriented electrical steel sheet of Patent Document 3, although it is described that the noise of a transformer is reduced, the iron loss is not sufficiently examined. In addition, attention is paid only to the difference in shape between the maximum magnetic flux density B and 0 T, and the time-magnetostriction waveform itself is not examined.

### PRIOR ART DOCUMENT

### Patent Document

[Patent Document 1] Japanese Patent No. 4216488

[Patent Document 2] Japanese Unexamined Patent Application, First Publication No. 2017-128765

[Patent Document 3] Japanese Patent No. 3500103

### DISCLOSURE OF THE INVENTION

### Problems to be Solved by the Invention

As described above, while various examinations have been hitherto made regarding grain-oriented electrical steel sheets that can lower iron loss and reduce noise, in recent years, a further improvement in performance has been required. An object of the present invention is to provide a grain-oriented electrical steel sheet capable of simultaneously reducing core loss and noise in a transformer based on the premise of a “magnetic domain control material” such as a laser irradiation material and an electron beam irradiation material used for application to a highly efficient stacked core transformer.

### Means for Solving the Problem

The present invention provides means of the following aspects.

[1] A grain-oriented electrical steel sheet according to an aspect of the present invention includes: a steel sheet; and optionally an insulation coating formed on the steel sheet, in which, in a case where a heat treatment of performing retention at 800° C. for 2 hours is performed, regarding a time-magnetostriction waveform (t−λ waveform) when magnetized to 1.7 T, a peak value of a difference waveform obtained by subtracting the time-magnetostriction waveform after the heat treatment from the time-magnetostriction waveform before the heat treatment is 0.01×10⁻⁶ or more and 0.20×10⁻⁶ or less and a difference obtained by subtracting an iron loss before the heat treatment from an iron loss after the heat treatment is 0.03 W/kg or more and 0.17 W/kg or less.

[2] In the grain-oriented electrical steel sheet according to [1], a linear or intermittently linear strain which is introduced in a direction intersecting a rolling direction of the steel sheet may be present on at least a surface of the steel sheet.

[3] A method of manufacturing a grain-oriented electrical steel sheet according to another aspect of the present invention is, a method of manufacturing the grain-oriented electrical steel sheet according to [1] or [2], including: linearly irradiating a surface of a grain-oriented electrical steel sheet with a laser beam or an electron beam.

### Effects of the Invention

In the grain oriented electrical steel sheet according to the aspect of the present invention, since the peak value of the difference waveform obtained by subtracting the time-magnetostriction waveform after the heat treatment from the time-magnetostriction waveform before the heat treatment is 0.01×10⁻⁶ or more and 0.20×10⁻⁶ or less, and the difference obtained by subtracting the iron loss before the heat treatment from the iron loss after the heat treatment is 0.03 W/kg or more and 0.17 W/kg or less, low transformer loss (iron loss) and low transformer noise can be achieved simultaneously in a case of application to a transformer.

### BRIEF DESCRIPTION OF THE DRAWINGS

FIG. 1 is a diagram showing an example of a time-magnetostriction waveform in a case where a grain-oriented electrical steel sheet before a stress relief annealing (SRA) is magnetized with a sinusoidal wave having a magnetic flux density amplitude of 1.7 T at a frequency of 50 Hz.

FIG. 2 is a diagram showing an example of a time-magnetostriction waveform in a case where a grain-oriented electrical steel sheet after the stress relief annealing (SRA) is magnetized with a sinusoidal wave having a magnetic flux density amplitude of 1.7 T at a frequency of 50 Hz.

FIG. 3 is a diagram showing the difference between the time-magnetostriction waveforms before and after the stress relief annealing (SRA).

### EMBODIMENTS OF THE INVENTION

A grain-oriented electrical steel sheet according to an aspect of the present invention is subjected to magnetic domain control.

The magnetic domain control has an effect of refining striped magnetic domains and reducing iron loss. The magnetic domain control can be confirmed by observing whether or not the striped magnetic domains are divided.

On the other hand, the magnetic domain control changes magnetostriction characteristics, and may change the noise level due to the change in the magnetostriction characteristics. This is because various vibration modes are generated in a structure by magnetostriction, and the vibration of the structure incurs the generation of noise. In a vibration mode of the structure, in addition to the vibration of a fundamental frequency, the vibrations of frequencies (higher harmonics) that are integral multiples of the fundamental frequency overlap. The fundamental frequency is, for example. 100 Hz in a case where the frequency of a magnetizing current is 50 Hz, and the frequencies of higher harmonics are 200 Hz, 300 Hz, 400 Hz, and the like.

The present inventors examined to reduce the noise level by changing the magnetostriction characteristics through magnetic domain control.

The present inventors found that changes in magnetostriction characteristics by magnetic domain control can be evaluated by the difference waveform (the time axis is the same) obtained by subtracting the time-magnetostriction waveform before the magnetic domain control from the time-magnetostriction waveform after the magnetic domain control, and surprisingly, found that if magnetic domain control conditions are constant, the difference waveforms are almost the same even if the magnetostriction waveforms of the parent samples are different.

In addition, as a result of the examination by the present inventors, it was found that by evaluating the shapes of the difference waveforms themselves without limitation to specific frequency components, it is possible to simultaneously control iron loss and noise characteristics with higher accuracy and good reproducibility.

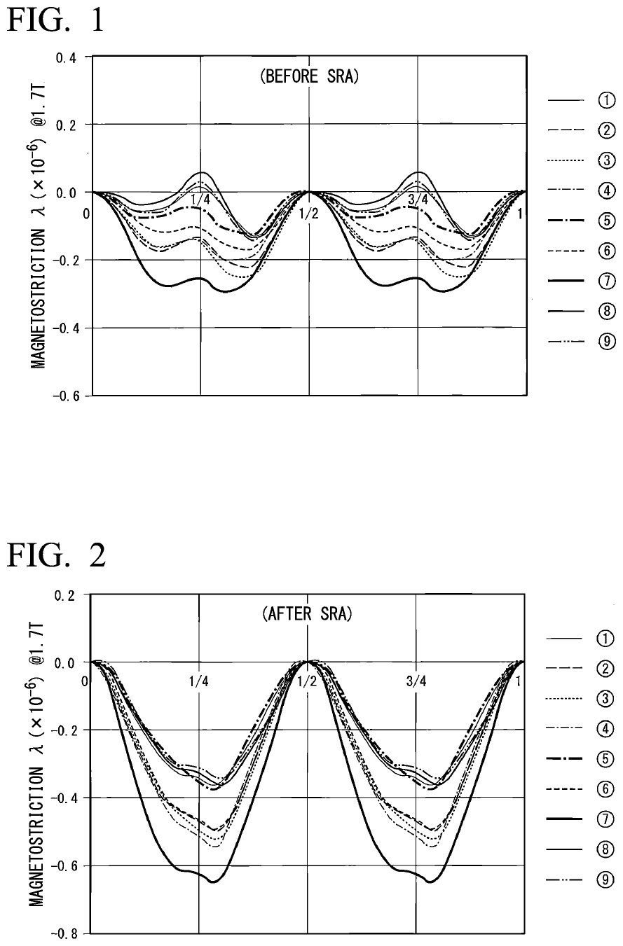

The above new findings will be described with reference to FIGS. 1 to 3.

First, the present inventors prepared nine kinds of high magnetic flux density grain-oriented electrical steel sheets (HGO), performed magnetic domain control thereon under the same conditions, and measured the time-magnetostriction waveforms. FIG. 1 is a superposition of the measured waveforms of the grain-oriented electrical steel sheets. Under the same magnetic domain control conditions, linear laser irradiation was performed at a laser output power P of 250 W and an interval PL (interval between irradiation lines) of 4 mm parallel to an orthogonal-to-rolling direction with an irradiation minor axis dL (diameter in a rolling direction) of 0.08 mm and an irradiation major axis dC (diameter in the orthogonal-to-rolling direction) of 1.0 mm.

Thereafter, the grain-oriented electrical steel sheets subjected to the magnetic domain control were subjected to stress relief annealing (SRA) at 800° C. for 2 hours as a heat treatment, and time-magnetostriction waveforms were measured. Table 2 shows the measurement results.

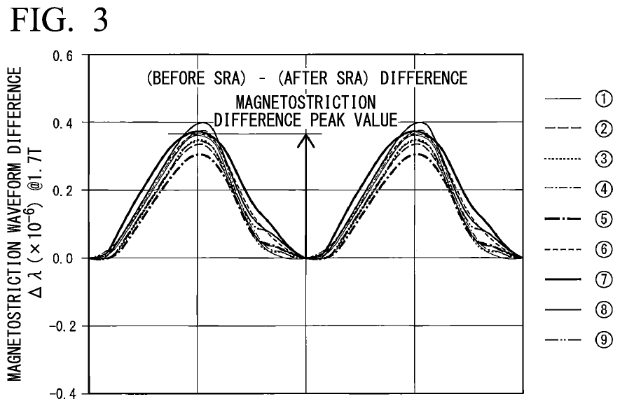

The difference waveforms obtained by subtracting the time-magnetostriction waveforms (FIG. 1) after the stress relief annealing (SRA) from the time-magnetostriction waveforms (FIG. 2) before the stress relief annealing (SRA) are shown in FIG. 3. Although the time-magnetostriction waveforms before and after the SRA were different waveforms, the difference waveforms before and after the SRA were almost the same waveforms for steels 1 to 9. It is considered that the reason is that the heat treatment eliminates the effect of magnetic domain control, but does not fluctuate the crystal orientation of the grain-oriented electrical steel sheet having a coarse grain size. Although the original magnetostriction waveform changes due to factors such as crystal orientation, since the difference waveforms are almost the same, it is considered that the difference waveforms correspond to the amount of change in the magnetostriction characteristics caused by the magnetic domain control performed under the same conditions. In other words, it is possible to quantify and evaluate the magnetostriction characteristics that are changed by magnetic domain control based on the difference in the magnetostriction waveforms before and after the heat treatment. In addition, in FIGS. 1 to 3, the horizontal axis is “time for one magnetization cycle”.

As described above it is possible to quantify a change in the magnetostriction characteristics by the magnetic domain control from the difference waveforms. Here, the peak value (amplitude) of this difference waveform is considered to be proportional to the closure magnetic domain volume of a magnetic domain control portion, and the difference waveform is mainly composed of a vibration component having a fundamental frequency. Therefore, when the change in magnetostriction of the difference waveform by the magnetic domain control is added to a base grain-oriented electrical steel sheet, although the vibration component of the fundamental frequency is canceled out, the higher harmonic components are relatively emphasized, which may lead to transformer noise. Therefore, transformer noise can be reduced by specifying the upper limit of the peak value (amplitude) of this difference waveform. Specifically, the peak value of the difference waveform is set to 0.20×10⁻⁶ or less.

On the other hand, when the peak value (amplitude) of the difference waveform is too small, the magnetic domain control effect is not sufficiently exhibited, and the transformer loss cannot be sufficiently reduced. Therefore, the peak value of the difference waveform is set to 0.01×10⁻⁶ or more.

In the grain-oriented electrical steel sheet according to the present embodiment subjected to the magnetic domain control, in a case where the iron loss before and after the heat treatment is measured and the difference between the measured values is obtained, the difference in iron loss (iron loss after the heat treatment—iron loss before the heat, treatment) is 0.03 W/kg or more and 0.17 W/kg or less.

When the difference in iron loss is less than 0.03 W/kg, an improvement in, the iron loss characteristics by the magnetic domain control is insufficient, and when the difference in iron loss exceeds 0.17 W/kg, the noise characteristics deteriorates.

From the viewpoint of quantifying the difference waveform before and after the magnetic domain control. it is necessary for the heat treatment to sufficiently eliminate the effect of the magnetic domain control. Therefore, the heat treatment temperature has to be set appropriately. As the heat treatment conditions, the heat treatment conditions may be set so that the effect of the magnetic domain control is sufficiently eliminated and an insulation coating of the grain-oriented electrical steel sheet is not deteriorated by appropriately combining the heat treatment temperature and the retention time, and as conditions, a heat treatment temperature may be 500° C. to 900° C. and a retention time may be 30 minutes to 8 hours.

When the heat treatment temperature is too high, not, only the effect of the magnetic domain control is eliminated, but also the insulation coating of the grain-oriented electrical steel sheet may be deteriorated. Therefore the upper limit of the heat treatment temperature is set to 900° C. On the other hand. when the heat treatment temperature is too low, there is concern that the effect of the magnetic domain control may not be eliminated. Therefore, the lower limit of the heat treatment temperature is set to 500° C.

In addition, the retention time of the heat treatment can be appropriately selected. However, when the retention time is too long, not only the effect of the magnetic domain control is eliminated, but also the insulation coating of the grain-oriented electrical steel sheet may be deteriorated. Therefore, the upper limit of the retention time may be 8 hours. When the retention time is too short, there is concern that the effect of the magnetic domain control may not be eliminated. Therefore, the lower limit of the retention time may be set to 30 minutes.

As an example of a combination of an appropriate heat treatment temperature and a retention time, 30 minutes or 4 hours and the like may be set at 780° C. or 850° C., 2 hours at 800° C. may be set. It is preferable that the heat treatment temperature is set to 800° C. and the retention time is set to 2 hours in order to stably obtain the effect of the stress relief annealing.

For the heat treatment, a batch annealing furnace, a continuous annealing furnace, or the like may be used. It is preferable to limit the temperature decreasing rate during cooling so that the temperature deviation in the grain-oriented electrical steel sheet to be annealed does not become excessive. As a specific example, for example, in a case of batch annealing, 30 minutes to 8 hours at 500° C. to 800° C. and a temperature decreasing rate of about 50° C./hr or less and 10° C./hr or more. for example, about 30° C./hr are preferable. When the temperature decreasing rate is too large, a temperature deviation occurs in a sample, residual strain occurs, and there is concern that the iron loss value or the like may deteriorate. On the other hand, when the temperature decreasing rate is too small, an excessively long heat treatment time is necessary, and an effect of avoiding residual strain is saturated. Therefore, it is preferable to set an appropriate temperature decreasing rate.

A method for the magnetic domain control is not particularly limited as long as desired properties can be obtained, in other words, as long as the peak value of the difference waveform and the iron loss difference specified in the present embodiment can be obtained, and laser irradiation, electron beam irradiation, mechanical strain introduction, and the like can be appropriately used. Although appropriate values of the conditions of each method for the magnetic domain control fluctuate slightly depending on the characteristics of the material, conditions may be grasped in advance with some materials and operation conditions and the like may be adjusted so that the difference waveform is in a good range shown in the present embodiment. Such adjustment is not so difficult for those skilled in the art who routinely adjust the operation conditions for controlling magnetostriction.

In the grain-oriented electrical steel sheet according to the present embodiment linear (continuously linear or intermittently linear) strain which is introduced in a direction intersecting the rolling direction of the steel sheet is present on at least the surface of the steel sheet (in a case of having an insulation coating, the surface of a steel sheet part excluding the coating), and the magnetic domain control may be realized by the linear strain. The surface of the steel sheet may be irradiated with a laser or an electron beam for a longer period of time with a lower irradiation power density than in the related art so that the peak value of the difference waveform and the iron loss difference specified in the present embodiment can be obtained. For example, with respect to the laser output power P (W), the irradiation minor axis dL (diameter in the rolling direction) and irradiation major axis dC (diameter in the orthogonal-to-rolling direction) of oblong irradiation are set to be sufficiently large, and the irradiation power density expressed by Ip=(4×P)/(π×dL×dC) is reduced, whereby the “peak value of the difference waveform and the iron loss difference” may be controlled within the specified ranges. The laser or the like may linearly irradiate the surface of the steel sheet.

The irradiation conditions of the laser or electron beam may be adjusted individually.

The irradiation energy (Ua) of the laser or electron beam may be set to 0.1 to 10 mJ/nm². This range is preferable in terms of an effect of sufficiently improving iron loss,

The laser diameter or electron beam diameter may be 0.001 to 0.4 mm in the case of a perfect circle. In the case of an ellipse, the minor axis dL is the same as the above, but the major axis dC may be set to 0.001 to 50 mm.

The number of pulses, pulse width, scanning speed, undulation conditions, and the like of the laser or electron beam, may be appropriately adjusted.

In the laser or electron beam irradiation, the focus lens or focus coil may be vibrated up and down, and the vibration may be synchronized with the scanning speed of the laser or electron beam for control.

Laser irradiation can be performed using a CO₂ laser, a YAG laser a fiber laser, or the like. From the viewpoint of reducing iron loss, it is desirable that magnetic domain control regions extend in a strip shape or a linear shape substantially at right angles to the rolling direction of the steel sheet, and the regions are periodically introduced in the rolling direction.

The magnetostriction characteristics also change depending on the tension applied to the steel sheet by the insulation coating. Therefore, the magnetostriction characteristics may be adjusted by forming the insulation coating on the grain-oriented electrical steel sheet. That is, the grain-oriented electrical steel sheet according to the present embodiment may be a grain-oriented electrical steel sheet having an insulation coating formed on the surface of the steel sheet. It is also possible to adjust the tension by adjusting the thickness of the insulation coating. For example, in the case of forming an insulation coating, the coating tension may be 1 to 20 MPa.

The sheet thickness of the grain-oriented electrical steel sheet according to the present embodiment is not limited, but is preferably 0.10 to 0.35 mm, and more preferably 0.15 to 0.27 mm in consideration of application to a transformer.

As a method of manufacturing the grain-oriented electrical steel sheet according to the present embodiment, for example, the surface of the grain-oriented electrical steel sheet is linearly irradiated with a laser beam or electron beam under the above-mentioned conditions.

### EXAMPLES

The present invention will be described with reference to the following examples. However, the present invention should not be construed as being limited to this example.

A high magnetic flux density grain-oriented electrical steel sheet having a sheet thickness of 0.23 mm manufactured by a normal method was subjected to linear laser irradiation at a laser output power P of 250 W and an interval PL of 4 mm parallel to an orthogonal-to-rolling direction while variously changing an irradiation minor axis dL (diameter in a rolling direction) and an irradiation major axis dC (diameter in the orthogonal-to-rolling direction), whereby magnetic domain control was performed. The irradiation energy was 2.1 mJ/mm², and the scanning speed of the irradiation beam was 30 m/s. A fiber laser was used as the laser. The time-magnetostriction waveform of each of the grain-oriented electrical steel sheet before a stress relief annealing (SRA) after the laser irradiation and the grain-oriented electrical steel sheet after the stress relief annealing (SRA) after the laser irradiation when subjected to sinusoidal magnetization to 1.7 T at a frequency 50 Hz was measured using a laser Doppler type magnetostriction measuring device. Since the response speed of the laser Doppler measuring device is sufficiently fast, the magnetization frequency when measuring magnetostriction is not limited to 50 Hz, and measurement can be performed at higher frequencies such as 100 Hz and 200 Hz. However, since a commercial magnetization frequency is 50 Hz to 60 Hz, the measurement was performed at 50 Hz.

Table 1 shows the sample preparation conditions and the magnetostriction measurement results (peak values of the difference waveforms before and after the heat treatment). The table also shows the difference in iron loss before and after SRA.

TABLE 1

| | | | | | Peak value of | | | Heat | |
|---|---|---|---|---|---|---|---|---|---|
| | | | | | magnetostriction | | | treatment | |
| | | | | | difference | Difference | Coating | temperature | Invention |
| | Ip*¹ | P | dL | dC | waveform | in iron loss | tension | (° C.) × time | Example/Comparative |
| Sample | (kW/mm²) | (W) | (mm) | (mm) | (×10⁻⁶) | (W/kg) | (MPa) | (hour) | Example |
| A | 21.2 | 250 | 0.03 | 0.5 | 0.52 | 0.09 | 12 | 800 × 2 | Comparative Example |
| B | 3.5 | 250 | 0.1 | 0.9 | 0.46 | 0.08 | 12 | 800 × 2 | Comparative Example |
| C | 2.0 | 250 | 0.2 | 0.8 | 0.35 | 0.08 | 12 | 800 × 2 | Comparative Example |
| D | 0.16 | 250 | 0.3 | 6.8 | 0.15 | 0.08 | 12 | 800 × 2 | Invention Example |
| E | 0.66 | 250 | 0.4 | 1.2 | 0.16 | 0.07 | 12 | 800 × 2 | Invention Example |
| F | 0.18 | 250 | 0.4 | 4.5 | 0.11 | 0.06 | 12 | 800 × 2 | Invention Example |
| G | 0.14 | 250 | 0.5 | 4.5 | 0.09 | 0.02 | 12 | 800 × 2 | Comparative Example |

*¹Power density Ip = 4P/(πdL · dC)

As can be seen from Table 1, the peak value of the magnetostriction difference waveform manufactured by a material under the irradiation condition in which Ip=(4×P)/(π×dL×dC) was 0.66 or less became small.

On the other hand, in Samples A to C, in which Ip was large, the peak value of the magnetostriction difference waveform became large.

However, in Sample G, the, magnetic domain control effect became insufficient as dL×dC increased and Ip decreased, and the magnetic domain width became wider, so that the difference in iron loss became excessively small.

Using these steel sheets A to G (the ones after laser irradiation and before SRA), three-phase three-limb stacked core transformers having a capacity of 400 kVA were manufactured. The maximum width of the steel sheet was 180 mm, and the number of stacked sheets was 650. The design magnetic flux density was Bd=1.7 T. Table 2 shows noise measurement results. The table also shows transformer loss.

TABLE 2

| | | Transformer noise | |
|---|---|---|---|
| | Ip*¹ | (dB (A)) | Transformer loss (W) |
| Sample | (kW/mm²) | f = 50 Hz, Bm = 1.7 T | f = 50 Hz, Bm = 1.7 T |
| A | 21.2 | 51 | 400 |
| B | 3.5 | 49 | 410 |
| C | 2.0 | 47 | 405 |
| D | 0.16 | 41 | 409 |
| E | 0.66 | 42 | 408 |
| F | 0.18 | 40 | 410 |
| G | 0.14 | 40 | 445 |

*¹Power density Ip = 4P/(πdL · dC)

As can be seen from Table 2, in examples using the grain-oriented electrical steel sheets D, E, and F in which the peak value of the difference waveform was 0.01×10⁻⁶ or more and 0.20×10⁻⁶ or less, and the difference obtained by subtracting the iron loss was 0.03 W/kg or more and 0.17 W/kg or less, the transformer noise and the transformer loss were reduced.

On the other hand, in examples using the grain-oriented electrical steel sheets A to C and G, either the transformer noise or the transformer loss was inferior.

### INDUSTRIAL APPLICABILITY

With the grain-oriented electrical steel sheet of the present invention, low transformer loss (iron loss) and low transformer noise can be achieved simultaneously. Therefore, high industrial applicability is achieved.

1. A grain-oriented electrical steel sheet comprising:
a steel sheet; and
optionally an insulation coating formed on the steel sheet,
wherein, in a case where a heat treatment of performing retention at 800° C. for 2 hours is performed,
regarding a time-magnetostriction waveform (t−λ waveform) when magnetized to 1.7 T, a peak value of a difference waveform obtained by subtracting the time-magnetostriction waveform after the heat treatment from the time-magnetostriction waveform before the heat treatment is 0.01×10⁻⁶ or more and 0.20×10⁻⁶ or less, and
a difference obtained by subtracting an iron loss before the heat treatment from an iron loss after the heat treatment is 0.03 W/kg or more and 0.17 W/kg or less.

2. The grain-oriented electrical steel sheet according to claim 1,
wherein a linear or intermittently linear strain which is introduced in a direction intersecting a rolling direction of the steel sheet is present on at least a surface of the steel sheet.

3. A method of manufacturing the grain-oriented electrical steel sheet according to claim 1 or 2, the method comprising:
linearly irradiating a surface of a grain-oriented electrical steel sheet with a laser beam or an electron beam.
